(19) United States
(12) Patent Application Publication
(10) Pub. No.: US 2021/0378400 A1
(43) Pub. Date: Dec. 9, 2021

(54) PLATFORM FOR A VARIABLE ADAPTABLE PIECE OF FURNITURE, SUCH A PIECE OF FURNITURE AND METHOD FOR CONTROLLING SUCH A PIECE OF FURNITURE

(71) Applicant: YAASA Living AG, St. Gallen (CH)

(72) Inventor: Stephan Egger, Speicher (CH)

(21) Appl. No.: 17/415,970

(22) PCT Filed: Dec. 12, 2019
(86) PCT No.: PCT/EP2019/084956

§ 371 Date: Jun. 18, 2021

(30) Foreign Application Priority Data
Dec. 18, 2018 (DE) 10 2018 132 690.4

(51) Int. Cl. A47B 85/04; A47B 13/08; A47B 21/06; A47C 3/40; A47B 21/02; A47B 9/20; A47B 21/04; G05B 15/02

(52) U.S. Cl. CPC A47B 85/04; A47B 13/081; A47B 21/06; A47C 3/40; A47B 2200/008; A47B 9/20; A47B 21/04; G05B 15/02; A47B 2200/0051; A47B 21/02

(57) ABSTRACT

The invention relates to a platform for a variably adaptable piece of furniture and to a piece of furniture with such a platform. The platform has a base, a column and a mounting bracket for mounting interchangeable accessory modules. The universal mounting bracket has a mechanical mounting interface for mounting and dismounting interchangeable accessory modules. The platform has electrical functionality. The platform also has an identification interface for identifying an accessory module mounted on the platform and a control unit. The control unit is adapted to receive identification information about an accessory module mounted on the platform from the identification interface and to control an adaptation of the electrical functionality of the platform depending on the received identification information.

The invention relates to a platform for a variably adaptable piece of furniture and to such a piece of furniture. The invention further relates to a method for controlling such a piece of furniture.

Electrically height-adjustable tables are known from the office sector. A special version of these tables are height-adjustable workstations that typically include holders for various devices, in particular monitors, computers or keyboards. Care trolleys are known from the hospital or care sector. Both workstations and care trolleys offer various storage options for various utensils and devices. Desks, for example lecterns, are also known from the office sector.

The disadvantage of the various solutions described is that they can only be used very specifically in an individual working or operating environment. In this respect, for example, a care trolley designed for the hospital or care sector is unsuitable as a workstation in an office environment. Due to the constant change and transformation in the need for and purpose of such furniture, there is a desire to be able to adapt such furniture as variably as possible to different application situations.

In addition, efforts are being made to design furniture with more and more operating comfort and “intelligence” as so-called “smart” furniture. In this way, more and more extensive electrical or electronic functionalities are being integrated into furniture.

It is thus an object of the invention to provide a platform, a piece of furniture and a method of the kind mentioned above that support flexible and variable adaptation to a variety of different applications.

This object is solved according to a first aspect by a platform according to claim 1. Advantageous further embodiments are disclosed in the subordinate claims.

The platform has a base for placing the platform on an installation surface, a column and a universal mounting bracket for mounting interchangeable accessory modules. The column is connected to the base. The universal mounting bracket is located at an end of the column facing away from the base. The universal mounting bracket has a mechanical mounting interface for mounting and dismounting interchangeable accessory modules to the platform. The platform has electrical or electronic functionality. The platform further comprises an identification interface for identifying an accessory module mounted on the platform and a control unit. The control unit is adapted to receive identification information about an accessory module mounted on the platform from the identification interface and to control an adaptation of the electrical or electronic functionality of the platform depending on the received identification information.

Such a platform allows for the flexible and variable assembly of a wide variety of interchangeable accessory modules. By mounting different accessory modules on the platform, various variably adaptable pieces of furniture can be provided. In this context, the term “platform” means a basic framework or a basic mechanism or a basic frame that can be expanded into various variable pieces of furniture by means of various interchangeable accessory modules.

The mounting interface is advantageously set up in such a way that interchangeable accessory modules can be mounted on or removed from the platform in a simple way, for example (screwless) with only one or a few hand movements. The mounting interface fixes an interchangeable accessory module stably to the platform. For this purpose, the mounting interface can, for example, have a clamping system, in particular a quick-clamping system, one or more clamps, one or more magnetic holders, or the like. In this way, interchangeable accessory modules can be quickly, flexibly and easily placed on or removed from the platform. Nevertheless, the accessory modules can be fixed to the platform in a mechanically stable way. Thus, the platform enables quick and easy adaptability to a wide range of applications, whereby different functionalities of the piece of furniture thus provided are supported by exchanging different accessory modules on the platform.

The platform also enables an accessory module mounted on the platform to be recognised via the identification interface. Advantageously, different accessory modules can be identified in this way. Based on the respectively mounted and identified accessory module, an automatic adaptation or modification of the electrical functionality of the platform can take place. This includes, for example, the adaptation or modification of parameters, operating modes or settings of the electrical functionality, the calling up or setting of stored parameters, operating modes or settings as well as the replacement of set parameters, operating modes or settings with new parameters, operating modes or settings.

For example, based on the respective mounted and identified accessory module, the electrical functionality of the platform in the form of an indicator or a display, in the form of a cooling or heating of the accessory module (via a corresponding cooling or heating unit of the platform), in the form of an electrical power supply (e.g. power saving states or the like) or in the form of a height adjustability or automatic height adjustment can be controlled or adapted.

The explained platform thus allows various accessory modules to be coupled with the platform via the mounting bracket. This enables variable and individual adaptability of a piece of furniture equipped with the platform to various different applications. Furthermore, the platform enables automatic adaptation to special operating and working situations due to the automatic adaptation or modification of the electrical functionality of the platform depending on the accessory module used and automatically recognised, while still being simple, flexible and safe to use. In this way, variable intelligent (smart) pieces of furniture can be easily configured and adapted by means of the platform.

In various embodiments, the identification interface is configured as electrical, mechanical or electromechanical interface. The identification interface has one or more identification or decoding units for recognising or decoding corresponding identification or coding features of a respective interchangeable accessory module.

In the case of an electrical configuration, the identification interface has, for example, an electrical or electronic identification or decoding unit for electrical detection, recognition or reading of electrical identification or coding features of an interchangeable accessory module. The identification interface can be set up as an electrical plug-in connection or as an inductive, electromagnetic interface, whereby an electrical detection of identification or coding features of the accessory module takes place electromagnetically. Alternatively or additionally, the identification interface can be set up as a capacitive interface. The identification interface can also be set up as a near field communication interface, for example as an NFC interface (NFC means “Near Field Communication”). Further alternatively, the identification interface can also be set up as an electronic, e.g. optoelectronic, interface for detecting and converting mechanical identification or coding features of an interchangeable accessory module into electrical identification or coding features.

In the case of a mechanical configuration, the identification interface comprises, for example, a mechanical identification or decoding unit for mechanically detecting or recognising identification or coding features of an interchangeable accessory module. For example, the identification interface may have one or more mechanical plugs or couplings or other coding means (e.g. pins or pegs) that react mechanically in different ways depending on the plugging, coupling or connecting behaviour of an interchangeable accessory module when the accessory module is mounted. These mechanical identification or coding features can then be converted into electrical identification or coding features via a separate processing unit.

In the case of an electromechanical design, the identification interface may also have a combination of the electrical/electronic or mechanical designs explained above.

The electrical, mechanical or electromechanical identification or coding features of an accessory module coupled to the platform generated or detected via the identification interface may be converted via the identification interface itself or via a downstream processing unit into electrical identification information which is made available to the control unit. In alternative embodiments and implementations, the identification or coding features themselves may already represent the corresponding identification information.

In various embodiments, the identification interface and the control unit can be set up and implemented in separate components. Alternatively, the identification interface and the control unit can be set up as a uniform assembly with corresponding logic.

In various embodiments, the mounting interface and the identification interface of the universal mounting bracket are set up, designed and/or positioned on the universal mounting bracket in such a way that when a replaceable accessory module is mounted on the platform by means of the mounting interface, an identification of an accessory module mounted on the platform is automatically carried out or can be carried out by means of the identification interface. In the case of a mechanical or electromechanical design of the identification interface, this can be integrated with its mechanical components in the mounting interface. Alternatively, the identification interface provides a separate mechanism.

In various embodiments, the electrical functionality (alternative or supplementary to other electrical functions) of the platform comprises an electrical height adjustability of the column. The control unit is set up to adapt the electrical height adjustability of the column depending on the identification information obtained.

In some embodiments, the control unit is configured, for example, to control or adapt one or more of the following functions of the electrical height adjustability of the column depending on the identification information received:
Activate or deactivate a lock on the height adjustment of the column,
Specify or change a defined safety or stop position (which is e.g. detected electrically or optically) or
Specify or change a maximum or minimum height of the column.

In alternative or supplementary embodiments, the control unit is set up to control an automatic height adjustment of the column depending on the identification information obtained. This enables automatic control of a height adjustment of the electrically height-adjustable column.

All embodiments in which a height adjustability or an active height adjustment of the column can be controlled or adjusted by means of the control unit using the identification information have the following advantages. If, for example, an accessory module is mounted on the platform via the mounting interface of the mounting bracket, which requires a special height of the platform (e.g. a presentation height for a whiteboard, pinboard, display, TV, etc.), the control unit can automatically preset or change functions, parameters, settings or operating modes of the height adjustability (as explained above) for this accessory module or, for example, actively control a movement of the column to the desired presentation height. If, on the other hand, for example, an accessory module is mounted on the platform via the mounting interface of the mounting bracket that requires a lower operating or working height (e.g. a height for a tabletop or a chair), the control unit can automatically preset or change functions, parameters, settings or operating modes of the height adjustability (as explained above) for this other accessory module or, for example, actively control a movement of the column to this desired lower operating or working height. The respective desired height or different functions, parameters, settings or operating modes of the height adjustability can be preset for different accessory modules, e.g. stored in a logical data memory of the platform and/or programmed via a programme logic.

An automatic adaptation of the height adjustability of the explained kind depending on a respective accessory module coupled to the platform therefore also has the advantage that a safe adjustment can be made without harming a user or the platform itself. For example, it can be prevented in this way that a vertically used plate-shaped accessory module is brought into a too low working height and hits the base of the platform or traps a user or the like.

In various embodiments of the platform, the universal mounting bracket additionally has an electrical connection interface for electrically connecting interchangeable accessory modules to the platform. The mounting interface and the connection interface of the universal mounting bracket are, for example, set up, designed and/or positioned on the universal mounting bracket in such a way that by mounting an interchangeable accessory module on the platform by means of the mounting interface, an electrical connection of the interchangeable accessory module with the connection interface can be established automatically.

The connection interface is advantageously set up in such a way that an interchangeable accessory module can be easily connected to an electrical or electronic system of the platform. The platform is advantageously designed in such a way that an electrical connection of the interchangeable accessory module with the connection interface can be automatically established by mechanically fixing an interchangeable accessory module by means of the mechanical mounting interface. This does not necessarily mean that every interchangeable accessory module usable with the platform must include electrical functionality. Interchangeable accessory modules with purely mechanical functionality can also be mounted on the platform. It is essential that the platform itself provides the functionality that by mechanically mounting an accessory module, an electrical connection of the accessory module is automatically possible.

The connection interface comprises, for example, an electrical plug with electrical contacts for interacting with electrical contacts of a mating plug on an interchangeable accessory module to be mounted (plug-coupling system).

Alternatively or additionally, the connection interface can also be set up for galvanically isolated or wireless electrical connection with a replaceable accessory module. For example, the connection interface can be set up as an inductive, electromagnetic interface, whereby an electrical connection between the platform and an interchangeable accessory module is made electromagnetically. Further alternatively, the connection interface can also be set up as a capacitive interface. The connection interface can also be set up as a near field communication interface, for example as an NFC interface (NFC means “Near Field Communication”). In the case of a galvanically isolated connection of the kind explained, the connection interface can have an energy transmission unit, in particular a transmitter/receiver unit (for example a coil), while a corresponding interchangeable accessory module can have a corresponding complementary energy transmission unit, in particular a transmitter/receiver unit (complementary coil). Thus, in the case of a galvanically isolated configuration, the connection interface forms a wireless power transmission system with a correspondingly configured interchangeable accessory module. In various embodiments, the connection interface is configured separately from the identification interface. In alternative embodiments, the connection interface and the (electrical or electromechanical) identification interface are grouped as a combined interface. In this case, an electrical interface and its electrical or electronic components provide both an identification and an electrical connection of a corresponding accessory module to the platform.

In this way, the platform is set up to electrically connect an interchangeable accessory module to the platform via the connection interface. Preferably, the mounting interface and the connection interface are configured and positioned on the platform or in relation to each other in such a way that mounting an accessory module automatically connects it electrically. In this way, no additional handles are required for an electrical connection of the accessory module in addition to one or more handles for mechanical mounting of the accessory module. For example, a separate connection of corresponding plugs between the accessory module and the connection interface can be omitted in addition to mounting the accessory module. Advantageously, the connection interface is arranged on the universal mounting bracket with respect to the mounting interface in such a way that, when the accessory module is mounted, the connection interface is concealed between the universal mounting bracket and the accessory module. This has the advantage that any electrics or electronics between the accessory module and the universal mounting bracket are protected from the outside world. The mounting interface and the connection interface (and possibly also the identification interface) can also be set up as a combined interface of the universal mounting bracket. In this way, at the same time a mechanical as well as an electrical connection of a replaceable accessory module and, if necessary, its automatic recognition is possible by means of one interface mechanism.

The explained platform thus enables variable mechanical and electrical adaptability via the mounting interface in conjunction with the connection interface and, if necessary, in conjunction with the identification interface, while still offering simple and flexible handling.

In various embodiments of the platform, the column is arranged perpendicular to the installation surface when the platform is upright and the column is telescopically adjustable in height. When the platform is upright, the base is set up on the installation surface, with the column projecting upwards perpendicular to the installation surface. At the upper end pointing away from the base, the universal mounting bracket is set up with the mounting interface and the identification interface and, if necessary, the electrical connection interface. The column may be centrally (in the middle) fixed to the base of the platform. For telescopic height adjustment, the column comprises, for example, two or three tubes that can be moved into each other, for example pushed into each other. However, a multitude (more than three) of tubes can also be used to set up a column with a high lift and at the same time a small size.

In various embodiments, an electric drive is integrated in the column for electric (electromotive) height adjustment of the column. The electric drive can, for example, comprise a linear actuator or linear motor. The electric drive is advantageously adapted to the desired or required lifting force. Furthermore, a gearbox designed for the desired lifting distance and/or the desired lifting force can be set up. For manual control/operation of the electric drive, for example, one or more operating elements or control elements may be integrated on or in the column or on or in the universal mounting bracket. Alternatively or additionally, the connection interface of the universal mounting bracket comprises one or more control lines for connecting one or more operating elements or control elements integrated in a corresponding interchangeable accessory module to be mounted.

For example, such an accessory module can be mounted on the platform, with an electrical connection of a control element on the accessory module to the connection interface of the platform, so that the electrical drive of the column can be controlled via the control element on the accessory module. Various variable configurations are conceivable here.

In various embodiments, the platform comprises a protection for blocking or releasing the electrical functionality, e.g. the electrical height adjustability or height adjustment of the column. The protection has, for example, a contact element for interacting with a counter-contact element for releasing or blocking the electrical functionality of the platform. For example, a corresponding protection is implemented in that a user card (smart card) has a contact element and, when the user card is inserted into or comes into contact with a corresponding device on the platform, the contact element interacts with a counter-contact element to enable or disable the electrical functionality. Interaction of the contact elements can take place, for example, electrically and/or magnetically and/or mechanically.

In various embodiments, the platform has a rechargeable battery (accumulator, battery) for supplying electrical energy to the platform, in particular for supplying electrical energy to the electrical functionality of the platform, and/or for supplying electrical energy to a replaceable accessory module mounted on the platform. For example, the battery may be set up on or in the column or on or in the base of the platform. In one embodiment, the battery may also be a replaceable battery.

Such designs have the advantage that the platform can be made mobile. In this way, the platform is independent of a wired external power supply, as long as the energy reserves of the battery are sufficient to operate the platform. For example, to charge the battery, connections can be provided on the platform to connect to a mains power supply. Alternatively, the battery can be charged, for example, by an inductive charging system. In this case, the platform can be coupled with its base to a charging adapter lying on the installation surface, integrated in the installation surface or, for example, integrated in a mat. Due to the energy supply via rechargeable battery, the platform is very well mobile and can, for example, be transported between different rooms without having to reconnect a wired external power supply. The platform is thus advantageously configured for a mobile, variable piece of furniture.

In the case of an electrically height-adjustable column of the kind explained above, the energy of the battery can be used primarily for the electric drive for height adjustment. Alternatively or additionally, in embodiments of the platform with an electrical connection interface of the kind explained, the energy supply of a replaceable accessory module with electrical functionality mounted on the platform can also be done by means of the connection interface of the universal mounting bracket. In this case, the energy from the battery can, for example, supply a device or a functionality of the accessory module. For example, a lamp is set-up on the accessory module, which can be supplied via the battery. Furthermore, in addition to a storage surface, the accessory module can also have, for example, an inductive charging option for a device placed on the accessory module, such as a laptop or smartphone or tablet computer, whereby the energy required to supply this device can in turn be fed from the battery. In this case, energy is transmitted between the battery, the connection interface of the universal mounting bracket to the accessory module and from the accessory module via a corresponding energy transmission to the coupled device. The battery thus provides a mobile auxiliary battery for supplying energy to electrical functionalities or devices that are coupled to a corresponding accessory module or are set up on the accessory module.

In various embodiments, the base has at least three feet. In special embodiments, a roller is arranged on at least two of the feet, respectively. This serves to displace the platform on the installation surface. A configuration with rollers additionally favours a mobility of the platform. The platform can be easily moved in space.

In alternative embodiments, the feet are set up without rollers. Here, for example, floor glides can be used in order not to cause damage to the installation surface when displacing the platform.

In various embodiments of the platform, the feet of the base are each designed as legs with the same leg length pointing away from a connection with the column. This means that all feet have the same leg length. One or more feet are advantageously pivotable relative to one or more other feet about an axis perpendicular to the installation surface (when the platform is upright). By pivoting one or more feet relative to other feet, it is possible to switch between a relatively wide and a relatively narrow set-up of the platform. For a space-saving arrangement, the feet can, for example, be pivoted in such a way that at least two feet span a very small angle (for example<15°) with their legs. The feet can preferably be swivelled in such a way that all legs of the feet are aligned almost parallel to each other. In this way, the platform can for example be positioned in very narrow places, for example in a niche. With this space-saving arrangement, however, the feet still span a standing surface that provides sufficient stability for the platform to remain upright. The space-saving arrangement of the feet of the type explained also has the advantage that in certain application situations the feet can be oriented in such a way that they do not obstruct a user of the platform.

In another orientation of the feet, they can be pivoted or oriented relative to each other in such a way that the feet form maximum angles (for example 80° to 120°) to each other. In such an orientation, the feet ensure a maximum stable standing surface of the platform.

In alternative embodiments of the platform, the feet are fixed to the column and are not pivotable relative to each other. In these embodiments, the base may, for example, be set up as a foot cross that has at least three feet.

In various embodiments, the universal mounting bracket is pivotably arranged on the column. For this purpose, a joint may be provided on the column by means of which the universal mounting bracket is held pivotably on the column. The universal mounting bracket can be pivotable in such a way that it can be pivoted around a horizontal axis (i.e. around an axis parallel to the installation surface when the platform is set up). Alternatively or additionally, the universal mounting bracket may also be pivotable in a vertical axis perpendicular to the horizontal axis (for example, about an axis perpendicular to the installation surface when the platform is set-up). In case of the platform being designed with feet on which rollers are mounted, alignment about such a vertical axis can alternatively or additionally also take place via these rollers.

The universal mounting bracket can be set up to pivot in such a way that it is possible to tilt from a substantially horizontal orientation (0°, main dimension of the universal mounting bracket substantially parallel to the installation surface) to a substantially vertical position (approx. 90°, main dimension of the universal mounting bracket substantially perpendicular to the installation surface). Between these two positions, the universal mounting bracket can assume any intermediate positions. In this respect, the platform, or more precisely, the universal mounting bracket, can be positioned very flexibly for a wide variety of applications in combination with an interchangeable accessory module as a flexible piece of furniture. The universal mounting bracket can also have releasable latching means (e.g. a gear coupling with the column) to keep the universal mounting bracket stable and secure in different angular positions and latched with respect to the column of the platform. By simply releasing and locking the latching means, the mounting bracket can be variably fixed in different angular positions with respect to the column.

In alternative embodiments, when the platform is upright, the universal mounting bracket is fixed to the column horizontally or vertically in its main dimension with respect to the installation surface. In these embodiments, the universal mounting bracket is not pivotable with respect to the column. A horizontal arrangement of the main dimension of the universal mounting bracket can be used, for example, for all table or storage or work surface applications. A vertical orientation of the main dimension of the universal mounting bracket can be used, for example, for applications of mounting of frames, screens, displays, whiteboards, pinboards or the like.

In various embodiments, the universal mounting bracket has a coupling interface for mechanical and/or electrical coupling with another universal mounting bracket of another platform. This has the advantage that several universal mounting brackets of different platforms or several platforms per se can be coupled mechanically and/or electrically in order to additionally expand the functional range of the platform or a piece of furniture assembled with the platform. In this way, two or more platforms can be coupled via their universal mounting brackets so that, for example, a work table can be constructed with two platforms. In the case of electrical functionality, an electrical coupling of several mounting brackets allows, for example, a synchronisation of a signal communication or an exchange of communication signals between the platforms involved, for example for synchronous electrical height adjustment of the respective columns of the platform (see above explanations). A mechanical coupling of several platforms can be advantageous, for example, to increase mechanical stability for certain applications. An electrical coupling of several platforms can take place via plug connections of corresponding plug contacts or also wirelessly or contactlessly (e.g. inductively or capacitively).

The mounting interface, the identification interface and/or the connection interface of the universal mounting bracket can be set up in such a way that they simultaneously provide the functionality of the coupling interface in addition to the functions of the type explained above. Alternatively, the coupling interface can be set up separately from the mounting interface, the identification interface or the connection interface on the universal mounting bracket. Further alternatively, the coupling interface is integrated elsewhere on the platform, for example on or in the column or on or in the base.

The above object is solved according to a second aspect by a variably adaptable piece of furniture according to claim 13. Advantageous further embodiments are disclosed in the subordinate claims.

The variably adaptable piece of furniture has a platform of the type explained above and an interchangeable accessory module. The accessory module is mounted or mountable on the universal mounting bracket of the platform by means of the mounting interface.

Such a variably adaptable piece of furniture also has the advantages mentioned in connection with the platform explained above. The accessory module can have a wide variety of functionalities, both mechanical and electrical.

In various embodiments of the variably adaptable piece of furniture, the interchangeable accessory module has at least one of the following functions:
Accessory module with a flat work surface (for example, for a simple table or worktop,
Accessory module with a holder for a book, tablet computer or smartphone (for example, simple edge),
Accessory module with a translationally and/or rotationally movable surface element (for example, side table),
Accessory module with a mount in accordance with a standard of the Video Electronics Standards Association (VESA) standard, for example as a display or TV mount,
Accessory module with a mechanical holder for objects that can be mounted on it, such as speakers, microphones, lighting fixtures, lamps, displays, cameras, drink holders, pen holders, trays, computer peripherals, keyboard rests or the like,
Accessory module with an electrical accessory interface for connecting or coupling electrical devices, for example USB or HDMI interface or similar or transmitter/receiver unit for wireless communication for example with a remote control or smartphone/tablet computer,
Accessory module with a coupling interface for mechanical and/or electrical coupling with a further accessory module, wherein the coupling interface is set up, for example, according to the kind explained above,
Accessory module with integrated whiteboard,
Accessory module with integrated display, in particular integrated touch display,
Accessory module with integrated, electrical operating or control element, for example switch for electrical height adjustment of the column of the platform,
Accessory module designed as a seat or armchair.

The interchangeable accessory module can have one or more (combination) of the functionalities explained above, as far as reasonably realisable. In this way, the piece of furniture can be adapted for completely different applications.

A variably adaptable piece of furniture of the kind described can advantageously be put together as a set with a number of other interchangeable accessory modules of the kind described above. Each of the accessory modules can be mounted on the universal mounting bracket of the platform by means of the mounting interface. The set can also have several platforms of the kind described. Advantageously, the accessory modules comprise several of the functions described above, so that the set can be used to set up functional pieces of furniture for various different applications by means of the one or more platforms.

The above object is solved according to a third aspect by a method according to claim 16 for controlling a variably adaptable piece of furniture of the kind explained above. Here, the identification interface of the platform automatically identifies the accessory module mounted on the platform. The control unit obtains identification information about the accessory module mounted on the platform, the identification information acquired by means of the identification interface. The control unit controls an adaptation of the electrical functionality of the platform depending on the obtained identification information. Such a method also results in the advantages explained above.

All advantageous aspects, features and implementations of the platform explained above are taken into account analogously in the variably adaptable piece of furniture explained further with such a platform or in a set explained further with a variably adaptable piece of furniture and a plurality of interchangeable accessory modules. Furthermore, all advantageous aspects, features and implementations of the platform explained above, of the variably adaptable piece of furniture explained above and of the set explained above with a variably adaptable piece of furniture and a plurality of interchangeable accessory modules are taken into account or reflected in corresponding aspects, features and implementations in the method explained further for controlling a variably adaptable piece of furniture and vice versa.

The invention is explained in more detail below by means of various embodiments with the aid of several drawings.

FIG. 1 shows a first embodiment of a platform according to the invention,

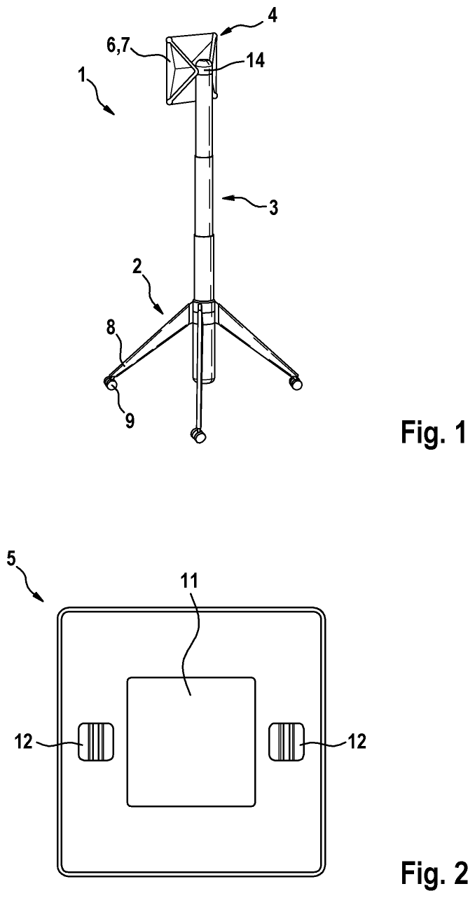

FIG. 2 shows an embodiment of an interchangeable accessory module for a platform according to FIG. 1,

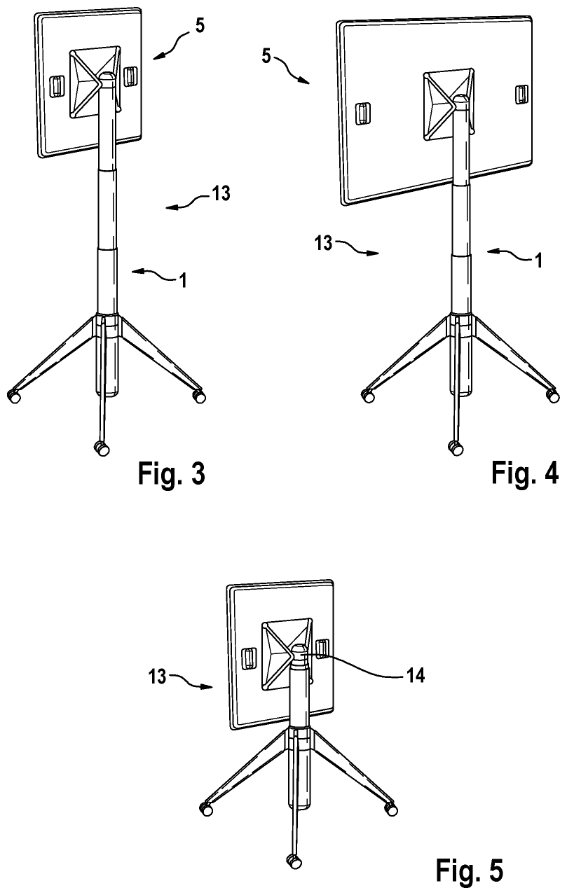

FIG. 3 shows a first embodiment of a piece of furniture with the platform according to FIG. 1 and an accessory module according to FIG. 2 mounted on it,

FIG. 4 shows a second embodiment of a piece of furniture with the platform according to FIG. 1 and an accessory module according to a further embodiment mounted on it,

FIG. 5 shows an electrical power supply on the piece of furniture according to FIG. 3,

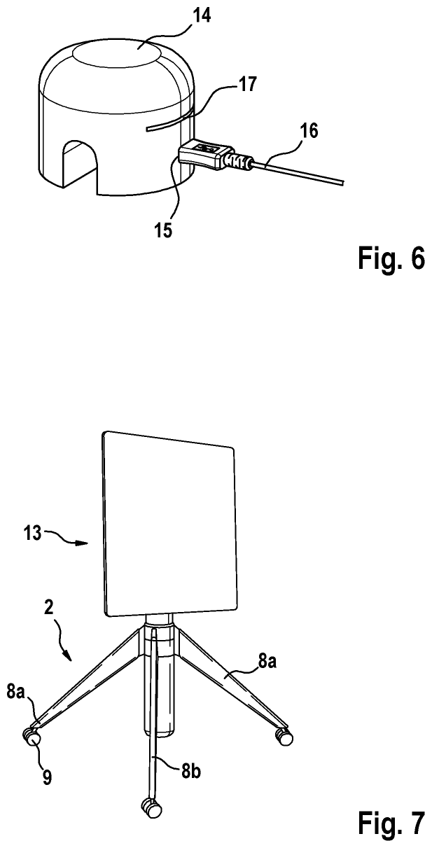

FIG. 6 shows an embodiment of the electrical power supply according to FIG. 5,

FIG. 7 shows the embodiment of the piece of furniture according to FIG. 3 with a first configuration of a base,

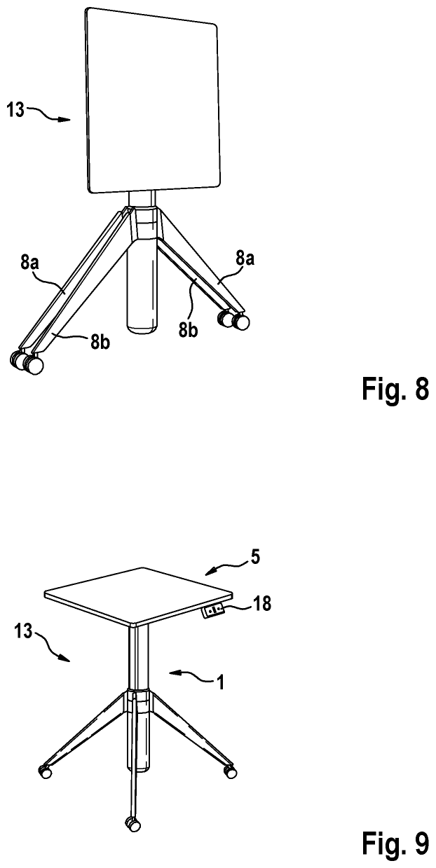

FIG. 8 shows the embodiment of the piece of furniture according to FIG. 3 with a second configuration of the base,

FIG. 9 shows a third embodiment of a piece of furniture with a platform and an interchangeable accessory module,

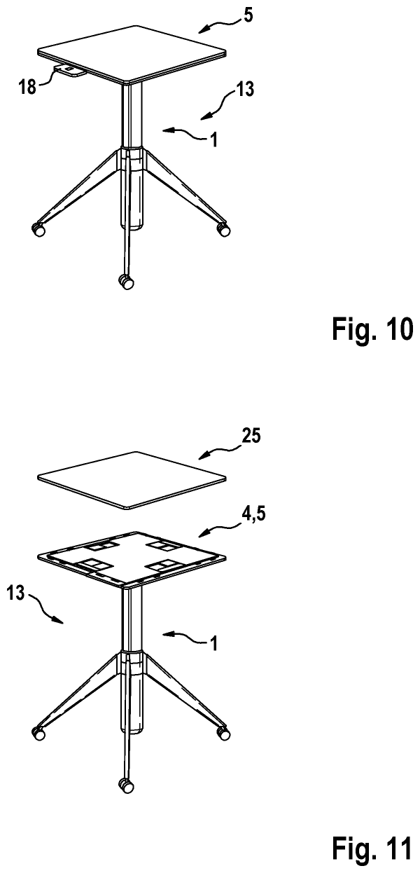

FIG. 10 shows a fourth embodiment of a piece of furniture with a platform and an interchangeable accessory module,

FIG. 11 shows a fifth embodiment of a piece of furniture with a platform and one or more interchangeable accessory modules,

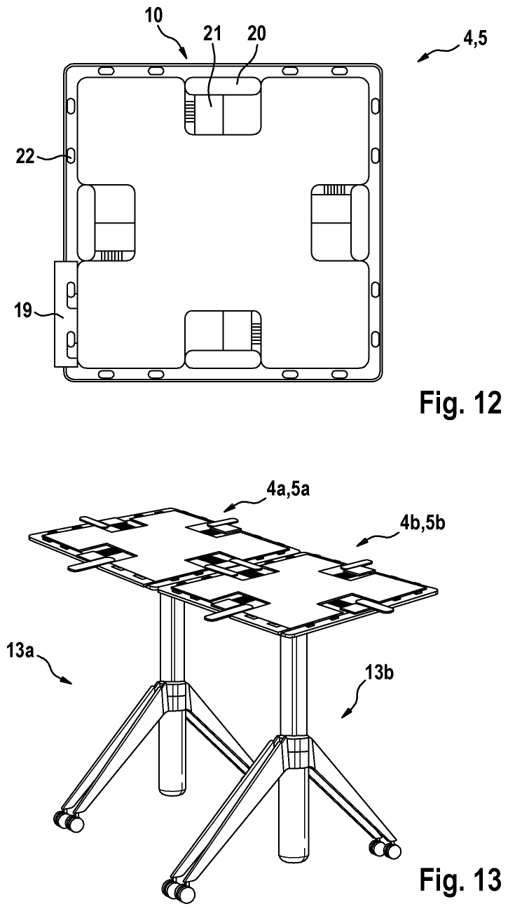

FIG. 12 shows a mounting bracket or an accessory module according to FIG. 11,

FIG. 13 shows an arrangement with two pieces of furniture as shown in FIG. 11,

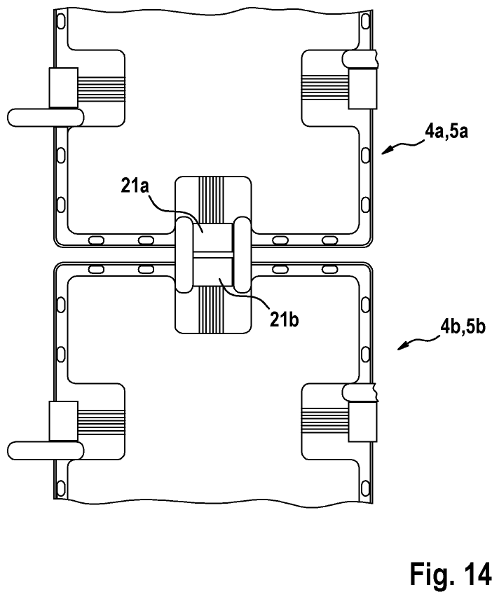

FIG. 14 shows an arrangement of the mounting brackets or accessory modules as shown in FIG. 13,

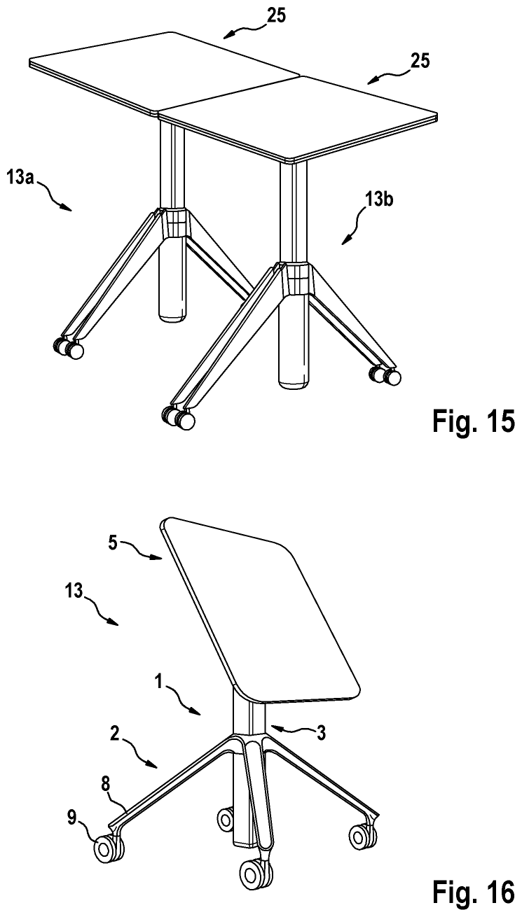

FIG. 15 shows a general view of the arrangement according to FIG. 13,

FIG. 16 shows a sixth embodiment of a piece of furniture with a platform and an interchangeable accessory module according to a first view,

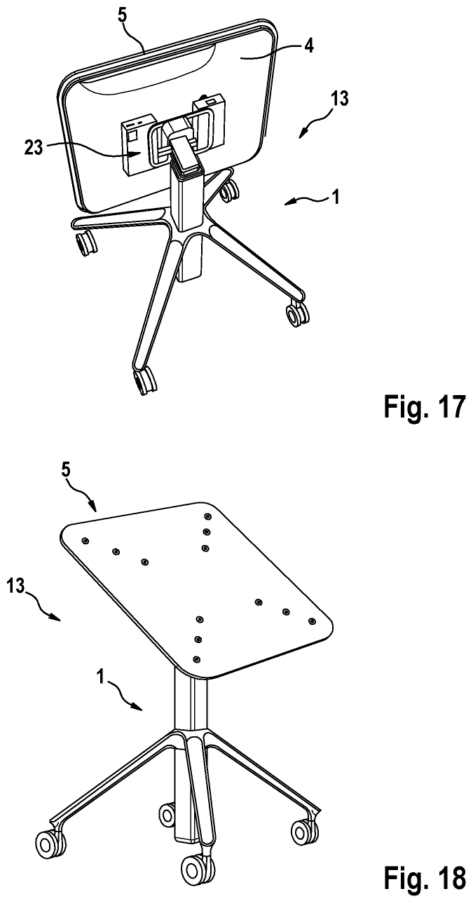

FIG. 17 shows another view of the piece of furniture according to FIG. 16,

FIG. 18 shows a seventh embodiment of a piece of furniture with a platform and an interchangeable accessory module,

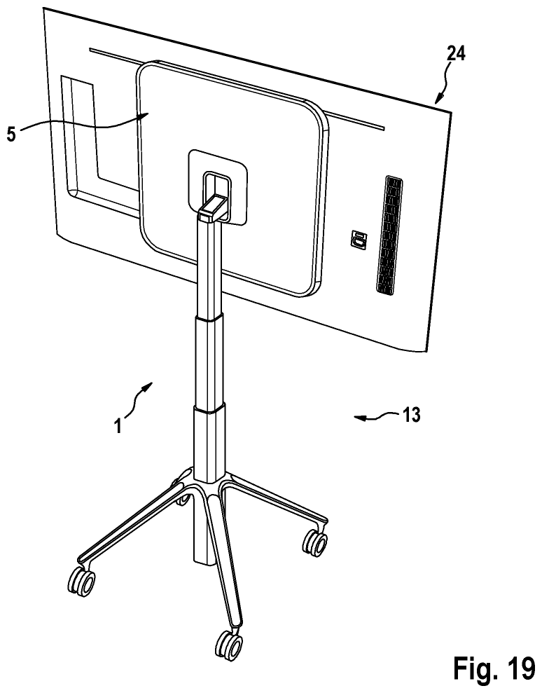

FIG. 19 shows an application of the piece of furniture according to FIG. 18,

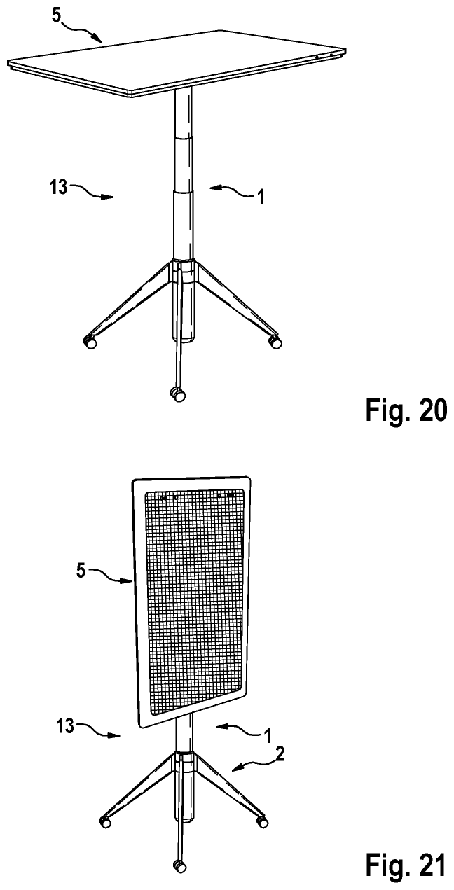

FIG. 20 shows an eighth embodiment of a piece of furniture with a platform and an interchangeable accessory module,

FIG. 21 shows a ninth embodiment of a piece of furniture with a platform and an interchangeable accessory module,

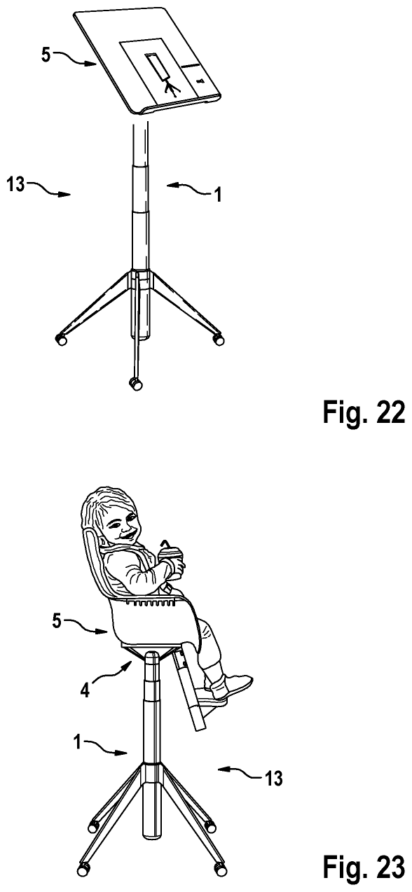

FIG. 22 shows a tenth embodiment of a piece of furniture with a platform and an interchangeable accessory module,

FIG. 23 shows an eleventh embodiment of a piece of furniture with a platform and an interchangeable accessory module,

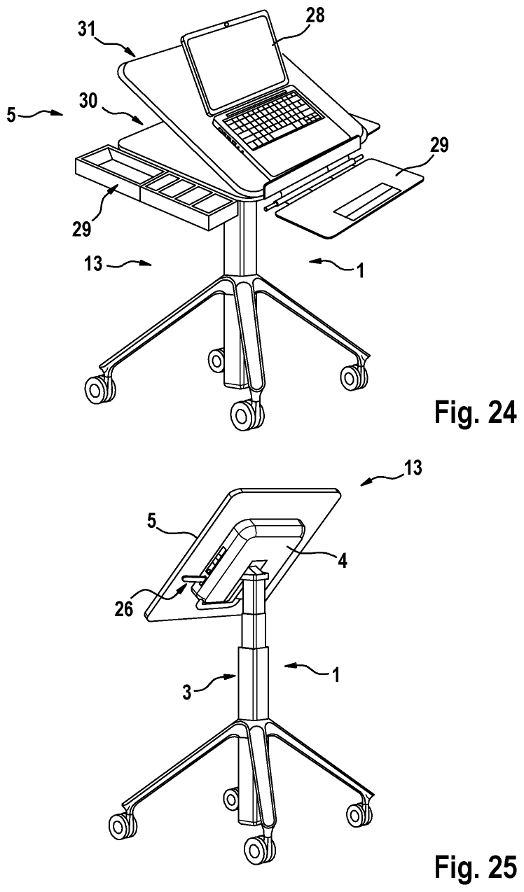

FIG. 24 shows a twelfth embodiment of a piece of furniture with a platform and an interchangeable accessory module,

FIG. 25 shows a thirteenth embodiment of a piece of furniture with a platform and an interchangeable accessory module according to a first view,

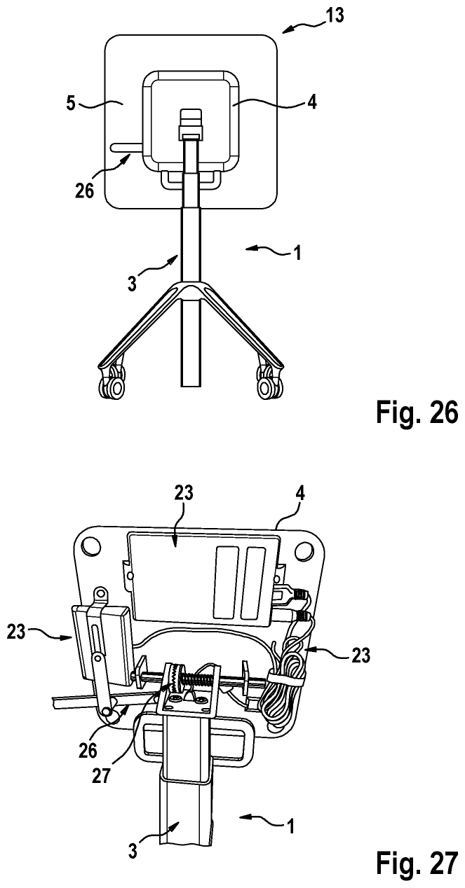

FIG. 26 shows another view of the piece of furniture according to FIG. 25,

FIG. 27 shows a part of the piece of furniture according to FIGS. 25 and 26, and

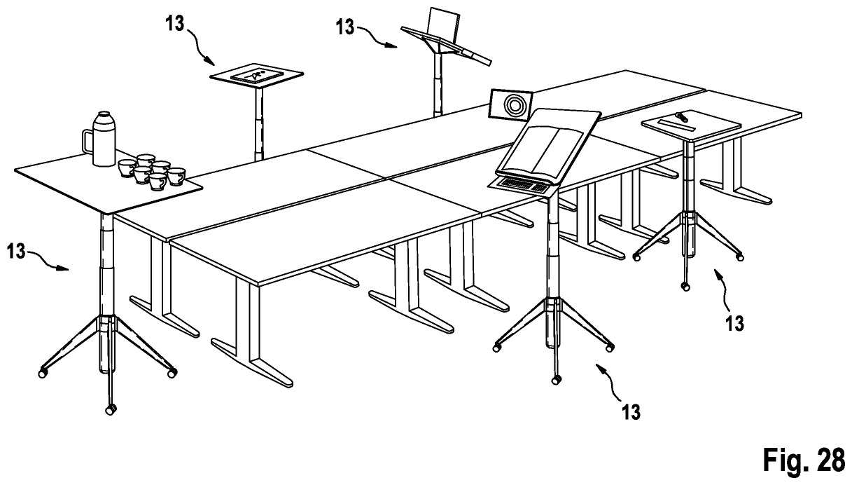

FIG. 28 shows different uses of various embodiments of pieces of furniture according to the invention.

FIG. 1 shows an embodiment of a platform 1 with a base 2, a column 3 and a universal mounting bracket 4. The base 2 has several feet 8 which, as legs, extend from a connection on the column 3 in the direction of a standing surface (installation surface) of the platform 1 and on each of whose peripheral ends a roller 9 is mounted for moving or displacing the platform 1 on the installation surface. At the upper end of the column 3 pointing away from a connection with the base 2, the universal mounting bracket 4 is connected to the column 3 via a bracket 14. In the exemplary embodiment according to FIG. 1, the universal mounting bracket 4 is pivotally mounted to the bracket 14. In particular, the universal mounting bracket 4 is pivotable in a horizontal axis (i.e. in an axis parallel to the installation surface or perpendicular to the main axis direction of the column 3). In addition, the universal mounting bracket 4 can be pivoted around the main axis of the column 3 (i.e. around an axis perpendicular to the installation surface).

In this embodiment, an electrical functionality of the platform 1 comprises an electrical height adjustability of the column 3. The column 3 is telescopically height adjustable. A height adjustment of the column 3 is carried out electrically (via an electric drive, for example a linear motor). In the embodiment according to FIG. 1, the column 3 comprises three tubular segments that are arranged so that they can be moved inside each other. The column 3 is centrally fixed to the base 2.

The universal mounting bracket 4 has a mounting interface 6 for mechanically mounting and dismounting an interchangeable accessory module. Furthermore, the universal mounting bracket 4 has an identification interface 7 for identifying an accessory module mounted on the platform 1. The interfaces 6 and 7 are configured and oriented or arranged on the mounting bracket 4 in such a way that when an interchangeable accessory module is mounted on the mounting bracket 4 by means of the mounting interface 6, the accessory module can be automatically identified via the identification interface 7. In this way, an accessory module can be fixed to the mounting bracket 4 in one or a few steps, while at the same time the accessory module is identified (ideally without the need for further handles or measures by a user).

The platform 1 further comprises a control unit (not explicitly shown), wherein the control unit is arranged to obtain identification information about an accessory module mounted on the platform 1, the identification information achieved by means of the identification interface 7, and to control an adaptation of the electrical height adjustability of the column 3, e.g. an automatic electrical height adjustment of the column 3, depending on the obtained identification information. For example, the control unit controls the electric drive for height adjustment of the column 3 in order to move the column 3 to a certain working or operating height depending on obtained identification information of a mounted accessory module. This can, for example, be stored or programmed in a data memory within the platform 1, e.g. within the control unit. Alternatively or additionally, the control unit controls an adaptation of parameters, operating modes or settings of the height adjustability of the column 3, e.g. calling up or setting stored maximum or minimum heights or a predetermined stop or safety position of the column 3.

Identification or coding features of an accessory module coupled to the platform 1 generated or recognised via the identification interface 7 can be converted via the identification interface 7 itself or via a downstream processing unit (not explicitly shown) into electrical identification information which is made available to the control unit. In alternative embodiments and implementations, the identification or coding features themselves may already represent the corresponding identification information.

The platform 1 thus enables a recognition of an accessory module mounted on the platform 1 via the identification interface 7 and an automatic adaptation of a height adjustability, e.g. a control of a height adjustment, of the electrically height-adjustable column 3 via the control unit. In the embodiment according to FIG. 1, the identification interface 7 and the control unit can be set up and implemented in separate components. Alternatively, the identification interface 7 and the control unit can be constructed as a uniform assembly with corresponding logic.

The mounting interface 6 can be determined, for example, by the outer dimension (main dimension) of the mounting bracket 4. In addition, the mounting bracket 4 can have predetermined latching means (not explicitly shown) for latching an accessory module to the mounting bracket 4. Such latching means may comprise, for example, clamps, quick-release clamps, latches, clips, magnets, magnetic holders, or the like. Screw connections are also conceivable.

In the embodiment according to FIG. 1, the identification interface 7 is realised, for example, as an electrical plug with electrical contacts (not shown) or as an galvanically isolated, wireless interface. The latter can, for example, work inductively or capacitively (e.g. as an NFC interface). For example, one or more induction coils are realised within the connection interface 7, which act as part of a wireless power/signal transmission system. Alternatively, the identification interface 7 has, for example, optoelectronics for evaluating and recognising mechanical identification or coding features of an accessory module mounted on the platform 1 and converting these identification or coding features into electrical identification information. In this way, identification or coding features of an accessory module coupled to the platform 1 can be exchanged between the accessory module and the identification interface 7 of the platform 1 and further processed by the latter.

In alternative embodiments, the identification interface 7 is mechanical or electromechanical. In this case, the identification interface 7 can detect mechanical identification or coding features (e.g. a specific coupling behaviour, a specific mechanical connector coding or one or more pegs or pins or corresponding counterforms) of an accessory module mounted on the platform 1 purely mechanically, whereby the mechanically detected identification or coding features are converted into electrical identification information, e.g. via a downstream processing unit. Alternatively, the identification interface 7 may electromechanically detect mechanical identification or coding features of the aforementioned type of an accessory module mounted on the platform 1. For example, the identification interface 7 can itself convert mechanically detected identification or coding features into electrical identification information.

In the embodiment according to FIG. 1, the electrically designed identification interface 7 also functions as an electrical connection interface for an electrical connection of a functionality that goes beyond the identification of the exchangeable accessory module, if the accessory module provides an electrical functionality that goes beyond the identification. In alternative embodiments, the electrical connection interface of the type explained is set up separately from the identification interface 7.

In this way, the platform 1 represents a multifunctional platform for interacting with an interchangeable accessory module of variable functionality to provide a variably adaptable piece of furniture. By mounting a wide variety of accessory modules on the mounting bracket 4, these can be coupled mechanically and, if necessary, electrically to the platform 1 in a simple and flexible manner. In this way, different pieces of furniture with different functionalities can be provided. Due to an automatic recognition of an accessory module coupled to the platform via the identification interface 7, an automatic adaptation of the height adjustability, e.g. a height adaptation of the platform 1 to a suitable or desired working or operating height of the platform 1, can take place. If, for example, an accessory module is mounted that requires a special presentation height for a whiteboard, pinboard, display, TV, etc., the control unit automatically controls a movement of the column 3 to the desired presentation height. If, on the other hand, an accessory module is mounted that requires a lower operating or working height, such as a height for a tabletop or a chair, the control unit automatically moves the column 3 to the desired lower operating or working height.

FIG. 2 shows an embodiment of an accessory module 5 which is designed to cooperate with a platform 1 as shown in FIG. 1. FIG. 2 shows a top view of a rear side of the accessory module 5. The accessory module 5 is essentially square in its external dimensions and comprises on its front side (opposite to the rear side shown), for example, a flat surface for providing a work surface. On the rear side shown in FIG. 2, there is a centrally arranged receptacle 11, which is set up as a negative shape to the outer main dimensions of the mounting bracket 4 of the platform 1 according to FIG. 1. The accessory module 5 can be placed with its receptacle 11 on the mounting bracket 4 of the platform 1 as shown in FIG. 1 and can be snapped onto the mounting bracket 4 with a precise fit. The accessory module 5 can have corresponding counter latching means for mechanical fixing to the mounting bracket 4, which are designed to be complementary to corresponding latching means of the mounting bracket 4 of the type explained. FIG. 2 shows in particular two fixing devices 12 which, for example, form part of a mechanical locking system between the accessory module 5 and the mounting bracket 4. The fixing devices 12 can, for example, actuate two latches (not shown) which can be operated via Bowden cables, whereby the accessory module 5 can be locked to the mounting bracket 4.

In this embodiment, the accessory module 5 comprises an electrical functionality, at least for an electrical identification of the accessory module 5. For this purpose, the accessory module 5 has an electrical interface which is set up complementary to the electrical identification interface 7 of the mounting bracket 4 in the embodiment according to FIG. 1. The accessory module 5 can provide electrical identification or coding features via its electrical interface. By mounting the accessory module 5 on the mounting bracket 4, an electrical recognition or identification of the accessory module 5 takes place automatically via the identification interface 7 of the platform 1 on the basis of the provided and detected identification or coding features of the accessory module 5.

In this way, the accessory module 5 as shown in FIG. 2 can be easily connected mechanically to the platform 1 and is automatically recognised via the identification interface 7 of the platform 1.

In alternative embodiments, the accessory module 5 does not necessarily have to provide electrical functionality. The accessory module 5 can have a purely mechanical functionality. In this case, the accessory module 5 is purely mechanically coupled to the mounting bracket 4 of the platform 1 as shown in FIG. 1. In this case, the accessory module 5 can be identified by an identification interface 7 of the platform 1, which is adapted according to the above explanations for FIG. 1 and which detects mechanical identification or coding features of the accessory module 5 and, if necessary, converts them into electrical identification information for further processing.

FIG. 3 shows a first embodiment of a variably adaptable piece of furniture 13, comprising a platform 1 according to FIG. 1 and an accessory module 5 mounted thereon according to FIG. 2. The accessory module 5 provides a certain functionality of the piece of furniture 13. For example, the accessory module 5 can have a work surface on its front side (not shown in FIG. 3) so that the piece of furniture 13 in the embodiment according to FIG. 3 can be used as a desk, photo wall, work table or side table. For this purpose, the mounting bracket 4 (compare FIG. 1 and above explanations) can be pivoted relative to the column 3 so that the accessory module 5 can be pivoted in predetermined degrees of freedom relative to the column 3. In the situation shown in FIG. 3, the accessory module 5 can be used, for example, as a vertical pinboard, whiteboard, photo wall, and so on. In alternative positions to FIG. 3, the accessory module 5 could be pivoted at an oblique (between 0° and 90°) angle with respect to the column 3 so that the accessory module 5 functions as a desk. In a further alternative position to FIG. 3, the accessory module 5 could also be pivoted to a horizontal position with respect to the column 3 so that the piece of furniture 13 functions as a work table or side table. Due to the height adjustability of the column 3 (see FIG. 1 and the above explanations), the height of the piece of furniture 13 can be flexibly adapted to various applications. An adaptation of the height adjustability of the column 3, e.g. an automatic height adjustment, takes place (or can take place) via the automatic recognition and identification of the accessory module 5 via the identification interface 7 of the platform 1, as explained above. Desired or required height positions or safety or stop positions or the like of the column 3 may be predetermined (e.g. stored) or programmed depending on a desired use or configuration of the accessory module 5. In particular, the column 3 can be brought into a maximum retracted position, whereby the piece of furniture 13 builds up compactly in height and can be positioned, for example, under a work table or desk. In a maximally extended position of the column 3, the piece of furniture 13 can build up to such a height that a user can work with it, for example, while standing. Corresponding height adjustments can also be controlled or predetermined by an automatic identification of the accessory module 5 or manually controlled by a user. Due to the movability of the rollers 9 (compare FIG. 1 and the above explanations), the piece of furniture 13 can be used in a mobile and flexible manner and is easy to transport.

FIG. 4 shows a second embodiment of a piece of furniture 13, wherein an accessory module 5 is mounted which is larger in its outer dimensions compared to FIG. 3. In this embodiment, the piece of furniture 13 can, for example, provide a board or a work table with larger dimensions compared to FIG. 3. Here, too, height adjustments can be controlled or specified by automatic identification of the accessory module 5 or manually controlled by a user, depending on the intended use.

FIG. 5 shows the embodiment of the piece of furniture 13 according to FIG. 3, whereby the holder 14 (compare also FIG. 1) is specified in more detail. In the embodiment according to FIG. 5, the holder 14 serves not only to hold the mounting bracket 4 but also to supply electrical energy to the platform 1. To this end, the holder 14 can have electrical switching or control means for supplying energy to the platform 1. In addition, the holder 14 may also have a battery for supplying electrical energy to the piece of furniture 13. In alternative embodiments, the battery can also be arranged elsewhere on the platform, in particular on or in the column 3 (cf. FIG. 1).

FIG. 6 shows a detailed view of the bracket 14, wherein an electrical indicator 17 and a connector 15 are provided on the bracket 14. The electrical indicator 17 serves as a status indicator for an electrical power supply of the piece of furniture 13 and/or generally as a status indicator of the piece of furniture 13. For example, the piece of furniture 13 may have a wireless communication device, the status of which can be indicated via the indicator 17.

A connection cable 16 can be plugged into connection 15, as shown in FIG. 6. The connection 15 and the cable 16 are set up as a USB interface, for example. Energy can be supplied to the holder 14 from outside via this interface, for example via a power supply unit of an external energy supply. In this way, energy can be supplied to the piece of furniture 13 in order to charge the battery.

Alternatively or in addition to such a charging option, the piece of furniture 13 can also have, for example, an inductive charging device that can be supplied with energy wirelessly, for example via floor contacts (charging mats, contacts in the installation surface, and so on).

In this way, the mobility of the piece of furniture 13 is further supported, whereby the piece of furniture 13 can operate electrically in a mobile manner without having to be permanently connected to an external mains supply. The power supply of the piece of furniture 13 serves in particular to supply an electric drive for the electrically height-adjustable column 3. Alternatively or additionally, depending on the design of the identification interface 7 explained above in connection with FIG. 1, the electrical power supply of the piece of furniture 13 may also serve to electrically detect or process identification or coding features of the accessory module 5 or, if applicable, to supply a mounted accessory module 5 (compare above explanations). For example, an electrical functionality of the accessory module 5 can be supplied with energy from the platform 1. For example, the accessory module 5 can have an electrically active interface (with electrically active components) for its identification in interaction with the identification interface 7 of the platform 1. For example, as a smart or intelligent accessory module 5, the accessory module 5 may have an electrical display or charging device for an electronic device coupled to the accessory module 5, such as a smartphone or tablet computer. The electrical power supply for this can be provided directly via the piece of furniture 13. This is provided by coupling the accessory module 5 to the platform 1 via the electrical identification interface 7 (compare FIG. 1), which can also be an electrical connection interface for the accessory module 5, as explained above.

FIG. 7 shows the embodiment of the piece of furniture 13 according to FIG. 3, now with a front side of the corresponding accessory module 5. FIG. 7 shows a first configuration of the base 2. Here, the individual feet 8a, 8b of the base 2 are pivotable relative to each other about the longitudinal axis of the column 3. This means that the feet 8a form a pair and the feet 8b (a second foot 8b is hidden by the column in FIG. 7) form a second pair. The two pairs of feet 8a, 8b can be pivoted relative to each other. In the constellation shown in FIG. 7, the feet 8a, 8b are positioned at a maximum possible angle (e.g. approx. 90°) to each other. This arrangement serves to ensure maximum stability of the piece of furniture 13. This is particularly useful if the weight of the piece of furniture 13 is high.

FIG. 8 shows a second configuration of the base 2, where the pairs of feet 8a, 8b are pivoted in contrast to FIG. 7 in such a way that one foot 8a is positioned close (e.g. at an angle<15°) to one foot 8b. Since the feet 8a, 8b are designed as legs with the same leg length, the rollers 9 of the feet 8a, 8b are arranged on an equal radius with respect to the column 3 as the centre of the base 2. This means that the feet 8a, 8b are arranged next to each other on the installation surface. In the constellation according to FIG. 8, a standing of the piece of furniture 13 is thus also still ensured. This means that the piece of furniture 13 is still standing independently. However, compared to FIG. 7, the feet 8a, 8b are arranged so close to each other that the piece of furniture 13 can be set up very compactly. For example, the piece of furniture 13 can be placed in a niche behind a cupboard or in a hallway or chamber, and so on. It is also conceivable that a constellation according to FIG. 8 is chosen for an application in which a user does not want to be obstructed by the feet 8a, 8b. This is desirable, for example, in a presentation by the user using the piece of furniture 13 as a presentation surface. By switching between the constellations according to FIG. 7 and FIG. 8, whereby intermediate positions of the feet 8a, 8b are of course conceivable, the user can switch between a maximum stable set-up of the piece of furniture 13 according to FIG. 7 and a maximum space-saving set-up of the piece of furniture 13 according to FIG. 8.

FIG. 9 shows a third embodiment of a piece of furniture with a platform 1 and an accessory module 5. The platform 1 can be constructed, for example, as in FIG. 1. In the embodiment shown in FIG. 9, the accessory module 5 has an operating/control element 18. The operating/control element 18 is used, for example, for manual height adjustment of the column 3 of the piece of furniture 13. The element 18 can, for example, be set up as a pushbutton for moving the column 3 upwards and downwards. Electrical control of the height adjustment can be effected via an electrical connection between the element 18 of the accessory module 5, the electrical identification or connection interface 7 of the mounting bracket 4 (compare explanations on FIG. 1) and an electrical drive of the column 3. A corresponding control unit (control electronics) for this can optionally be set up either in the accessory module 5 and/or in the platform 1. Various configurations are possible here.

FIG. 10 shows a fourth embodiment of the piece of furniture 13, whereby the accessory module 5 also has an operating control element 18 which, however, is configured differently compared to FIG. 9. In FIG. 10, the element 18 is, for example, an extended control element which, in addition to purely controlling an electrical height adjustment of the column 3, also has, for example, a display for the height adjustment. The control element 18 can also have a memory function, for example, in order to store a specific working height of the piece of furniture 13 for selection. The element 18 can also have a safety device for locking or releasing the electrical height adjustment of the column 3. This is then activated or released, for example, via a user card (smart card). The control element 18 according to FIG. 10 can also have, for example, a transmitter/receiver unit for an external remote control or for communication with a smartphone or tablet device. For example, a remote control or a software application can be used to wirelessly operate/control the element 18.

FIG. 11 shows a fifth embodiment of a piece of furniture 13 with a platform 1 and a specially equipped accessory module 5 or a specially equipped mounting bracket 4. The mounting bracket 4 or the accessory module 5 according to FIG. 11 have a special coupling interface which is explained in more detail in FIG. 12. According to FIG. 11, a further module 25 can be placed on the mounting bracket 4 or on the accessory module 5 as a cover plate. In embodiments according to FIG. 11, in which the mounting bracket 4 is set up accordingly, the cover plate 25 functions as an accessory module that can be mechanically coupled to the mounting bracket 4 as explained above. In embodiments according to FIG. 11, in which the accessory module 5 is configured accordingly, this is itself mechanically coupled to a mounting bracket 4 (for example according to FIG. 1), whereby the accessory module 5 is in turn mechanically coupled to the cover plate 25.

FIG. 12 shows a top view of the mounting bracket 4 or the accessory module 5 according to FIG. 11. The component 4, 5 has a total of four coupling interfaces 10, which are set up on the four outer edges. The coupling interfaces 10 each have a mechanical slider 20 and an electrical contact plug 21. Via the slider 20, the contact plugs 21 can each be swivelled from a retracted position shown in FIG. 12 to an outer coupling position. In the latter position, the contact plugs 21 of the components 4, 5 can be electrically and/or mechanically coupled with a further contact plug 21 of a further component 4, 5. In this way, several components 4, 5 of several pieces of furniture 13 can be coupled mechanically and/or electrically.

In addition, the component 4, 5 as shown in FIG. 12 has a holder 19 (compare lower left corner) which is fixed to locking pins 22 of the component 4, 5. The holder 19 serves as an adapter piece for combining the component 4, 5 with further mechanical components, which can be, for example, a holder for a book, tablet device or smartphone or further objects that can be mounted on the component 4, 5, such as speakers, microphones, lighting fixtures, displays, cameras, drink holders, pen holders, trays, computer peripherals, keyboard supports and so on. Here, a variety of configuration options are provided for the piece of furniture 13. Referring to FIG. 11, the holder 19 is appropriately held in place by, among other things, the cover plate 25, which is placed on the component 4, 5, so that further components can be stably secured to the holder 19 at the side of the component 4, 5. It is possible to mount several holders 19 along the outer circumference of the component 4, 5 on corresponding pins 22.

FIG. 13 shows an arrangement with two pieces of furniture 13a, 13b, each set up as shown in FIG. 11. In FIG. 13, the respective cover plates 25 have been omitted for simplicity. FIG. 13 illustrates a mechanical and/or electrical coupling of two components 4a, 5a and 4b, 5b of the respective pieces of furniture 13a, 13b.

FIG. 14 shows a section of a top view of the coupled components 4a, 5a and 4b, 5b. Two contact plugs 21a and 21b are folded outwards and electrically connected via sliders 20 (compare FIG. 12). In this way, electrical communication or synchronisation takes place between the components 4a, 5a and 4b, 5b. An application of the constellations according to FIG. 13 and FIG. 14 can be, for example, to combine two pieces of furniture 13a and 13b into a complete piece of furniture, whereby, for example, a work table with two columns can be realised. In the case of electrical height adjustment of the respective columns, for example, electrical synchronisation of a height adjustment can take place by means of the coupled components 4a, 5a, 4b, 5b for synchronous adjustment of the height of the combined overall piece of furniture. Alternatively or additionally, the components 4a, 5a and 4b, 5b can also exchange further signals with each other and communicate accordingly.

Finally, FIG. 15 shows the arrangement according to FIG. 13 with cover plates 25 now mounted on the surface of components 4a, 5a and 4b, 5b. In this way, a stable, wide work table with two columns is realised, which are provided in combined form via the respective pieces of furniture 13a and 13b.

FIG. 16 shows a sixth embodiment of a piece of furniture 13 with a platform 1 and an accessory module 5 mounted on it. Analogous to FIG. 1, the platform 1 has a base 2 and a column 3. The column 3 is also adjustable in height. In contrast to the embodiment of the platform 1 according to FIG. 1, the base 2 has several feet 8 which, however, are fixed to each other. In this respect, the base 2 in the embodiment according to FIG. 16 forms a fixed foot cross of the feet 8. In this embodiment, the feet 8 cannot be swivelled in relation to each other. Rollers 9 are mounted on the feet 8.

The accessory module 5 according to the embodiment in FIG. 16 can also be set up to swivel via a corresponding mounting bracket 4. The accessory module 5 is connected/recognised in the same way as described above and requires no further explanation here.

FIG. 17 shows another representation of the embodiment from FIG. 16. FIG. 17 shows a rear side of the mounting bracket 4 or the accessory module 5. In this embodiment, the mounting bracket 4 has electronics 23 mounted near the centre of the mounting bracket 4. The electronics 23 may comprise, for example, a control unit (control electronics) of the type explained above for automatic and/or manual adjustment of the electrical height adjustability of the column 3. Alternatively or complementarily, the electronics 23 may comprise a wireless communication interface, an electrical power supply (e.g. by battery), and so on for communication with external devices (e.g. smartphones), for powering the platform 1 and/or for connecting an electrical functionality (if any) of the accessory module 5. Various configurations are possible here.

FIG. 18 shows a seventh embodiment of a piece of furniture 13 with a platform 1 and an accessory module 5 mounted thereon. In this embodiment, the accessory module 5 is a VESA adapter for mounting an electronic device.

FIG. 19 shows an application of the piece of furniture 13 according to FIG. 18. Here, a TV set 24 or a similar display is mounted on the accessory module 5. The piece of furniture 13 is located with the platform 1 at a working height at which a user works with the TV set 24. A coupling of the accessory module 5 to the platform 1 is carried out analogously to the above explanations. Due to an automatic recognition and identification of the accessory module 5, the column 3 has been moved by the control unit of the platform 1 to the working height shown in FIG. 19 (e.g. from the mounting height shown in FIG. 18). The illustrated mounting height can be set via the control unit, whereby a movement of the column 3 is controlled manually by a user. Alternatively, the column 3 is automatically brought to the mounting height shown via the control unit.

It is conceivable, for example, that a user has different accessory modules 5 according to FIGS. 16 to 19 for different applications and combines each of these with a platform 1 as a variably adaptable piece of furniture 13. For example, a user can switch between the piece of furniture 13 as a side table, desk or work table according to FIGS. 16 and 17 and between a VESA adapter for setting up a display 24 according to FIGS. 18 and 19. The platform 1 is multifunctional in such a way that a corresponding functionality of the respective accessory modules 5 can be realised in a simple manner. Various operating and working heights of the column 3, which can be predefined or programmed, are adapted accordingly or actively controlled by the control unit. This is done, as explained above, in interaction with identification information about the respective accessory module 5, which is obtained by means of the identification interface 7 and processed by the control unit to control a height adjustment of the column 3.

FIG. 20 shows an eighth embodiment of a piece of furniture 13 with a platform 1 and an accessory module 5 mounted thereon, which in FIG. 20 is set up as a larger worktop. In the embodiment according to FIG. 20, the mounting bracket 4 (not shown) may be fixedly mounted to the column 3 (compare FIG. 1) in a horizontal position of its outer main dimensions. In this case, the accessory module 5 as shown in FIG. 20 is arranged in a fixed (non-pivotable) position. This is conceivable, for example, in applications where only a horizontal plane surface of the accessory module 5 is to be used. Nevertheless, the height of the piece of furniture 13 can be adjusted on the column 3. In addition, the platform 1 can be set up, for example, as explained with regard to FIG. 1. Also in this embodiment, different operating and working heights of the column 3 can be preset, adjusted or actively approached by the control unit in interaction with the identification interface 7.

FIG. 21 shows a ninth embodiment of a piece of furniture 13 with a platform 1 and an accessory module 5 mounted thereon. In contrast to FIG. 20, the accessory module 5 is arranged in a vertical orientation along the column 3 (compare FIG. 1). It is also conceivable that a mounting bracket 4 is fixed to the column so that the position of the accessory module 5 shown in FIG. 21 is fixed (not pivotable). Such applications are useful, for example, for functionality of the piece of furniture 13 as a pinboard or whiteboard or other presentation surface. In addition, the platform 1 can be set up, for example, as explained for FIG. 1. In this embodiment, too, various operating and working heights of the column 3 can be preset, adjusted or actively approached by the control unit in interaction with the identification interface 7. Such an automatic height adjustment or presetting of a height of the column 3 by the control unit has the advantage, especially in this application, that an impact of the accessory module on the base 2 of the platform 1 can be prevented. A corresponding minimum height of the column 3 (possibly depending on the dimensions of the accessory module 5) for the safe use of the accessory module 5 can, for example, be specified in or by the control unit or stored in a data memory of the platform 1 and processed by the control unit.

FIG. 22 shows a tenth embodiment of a piece of furniture 13 with a platform 1 and an accessory module 5 mounted thereon. In this embodiment, the accessory module 5 can in particular provide an electronic functionality. For example, the accessory module 5 may be a display, in particular a touch display. The accessory module 5 is electrically connected via an identification/connection interface 7 (compare above explanations). An application of the constellation in FIG. 22 is conceivable, for example, for a graphic designer who wishes to work either standing up or sitting down. The height of the piece of furniture 13 can be adjusted manually or automatically via the control unit using the height-adjustable column 3. The platform 1 can, for example, be set up as explained with regard to FIG. 1.

FIG. 23 shows an eleventh embodiment of a piece of furniture 13 with a platform 1 and an accessory module 5 mounted thereon, which is fixed to the platform 1 via the mounting bracket 4. In the embodiment shown in FIG. 23, the accessory module 5 is set up as a child seat. Here too, the height of the platform 1 can be adjusted manually via the column 3 (see FIG. 1) or automatically via the control unit. The platform 1 can, for example, be set up as explained for FIG. 1.

FIG. 24 shows a twelfth embodiment of a piece of furniture 13 with a platform 1 and an interchangeable accessory module 5 mounted thereon. In the embodiment according to FIG. 24, the accessory module 5 is designed as a more complex work table/secretary platform. For this purpose, the accessory module 5 has a horizontally arranged base plate 30 which is mounted on the mounting bracket (not shown) of the platform 1. A worktop 31 is in turn pivotally arranged on the base plate 30, which can be arranged in one or more acute angular positions with respect to the base plate 30. In the embodiment shown in FIG. 24, the work surface 31 serves as a receptacle/storage surface for a mobile computer, such as a laptop 28 or tablet or the like. On the sides of the base plate 30, various shelves 29 are provided for keyboard or other peripheral devices or for writing utensils, office materials, etc. The advantage of this embodiment is a versatile working environment in which a variety of accessories can be used and stored, whereby the work surface 31 can be variably positioned with respect to the base plate 30 (e.g. for an optimal operating or viewing position for the laptop 28) and yet all other accessories can remain in a horizontal position by means of the shelves 29. The platform 1 can, for example, be set up as explained for FIG. 1.

FIGS. 25 and 26 show a thirteenth embodiment of a piece of furniture 13 with a platform 1 and a replaceable accessory module 5 in two different views and positions of the accessory module 5. The accessory module 5 is mounted on the mounting bracket 4. The mounting bracket 4 is pivotable with respect to the column 3 and lockable in various discrete detent positions. The accessory module 5 can thus be brought into different angular positions with respect to the column 3. For locking or releasing a stable locking position, an operable lever 26 is arranged on the mounting bracket 4. A locking device 27 (see FIG. 27) can be operated via this lever 26. FIG. 25 shows an oblique angular position of the accessory module 5 with respect to the column 3. FIG. 26 shows an essentially vertical angular position of the accessory module 5 with respect to the column 3.

FIG. 27 shows a part of the piece of furniture 13 according to the embodiment of FIGS. 25 and 26. Here, a cover of the mounting bracket 4 is removed so that an inner area of the mounting bracket 4 is visible. This shows the latching device 27, which in this embodiment is designed as a pre-tensioned gear coupling. The lever 26 can be used to disengage the preloaded gear coupling so that the mounting bracket 4 can be pivoted together with the accessory module 5. When lever 26 is not actuated, the gear coupling is engaged and locks the mounting bracket 4 together with the accessory module 5 in the desired position. In addition to this mechanism, FIG. 27 also shows components of electronics 23, which in this embodiment comprises a battery, a control unit for controlling a drive for the height adjustment of the column 3 and wiring. The electronics 23 can of course comprise further components, in particular of the type explained above. The platform 1 of the embodiment of FIGS. 25 to 27 can, for example, be set up as explained for FIG. 1.

FIG. 28 shows an overview of various application scenarios for the variably adaptable pieces of furniture 13 described here. The pieces of furniture 13 can be used, for example, as a side table, small work table, standing desk, and so on. It is conceivable, for example, to provide a wide variety of accessory modules 5 for different functionalities, which are combined mechanically and, if necessary, electrically with a corresponding platform 1. For example, it is conceivable to provide a set with one or more platforms 1 of the type explained above and a plurality of interchangeable accessory modules 5, 5a, 5b of the type explained above, wherein the interchangeable accessory modules 5, 5a, 5b can each be mounted and connected to the universal mounting bracket 4, 4a, 4b of the at least one platform 1 by means of the corresponding mounting interface 6 and by means of the corresponding identification/connection interface 7. An automatic recognition and identification of the exchangeable accessory modules 5, 5a, 5b takes place via the identification interface 7, whereby via the control unit of the platform 1 desired working and operating heights of the column 3 are preset or automatically controlled in dependence on the respectively identified accessory module 5, 5a, 5b.

The variably usable piece of furniture 13 explained here offers a user advantages of a mobile, variable, flexible and safe application and provides a very flexible adaptability of the piece of furniture specifically for different use cases and situations by means of a universal bracket and recognition of interchangeable accessory modules.

The embodiments shown are merely selected as examples.

### LIST OF REFERENCE SIGNS

1 Platform
2 Base
3 Column
4, 4a, 4b Universal mounting bracket
5, 5a, 5b Accessory module
6 Mounting interface
7 Identification interface
8, 8a, 8b Foot
9 Roller
10 Coupling interface
11 Holder for mounting bracket
12 Fixing device
13, 13a, 13b Piece of furniture
14 Bracket
15 Connection
16 Cable
17 Display
18 Operating/control element
19 Bracket
20 Slider
21, 21a, 21b Contact plug
22 Pin
23 Electronics
24 TV
25 Cover plate
26 Lever
27 Latching device
28 Laptop
29 Shelve
30 Base plate
31 Worktop

1. A platform for a variably adaptable piece of furniture, the platform comprising:
a base for placing the platform on an installation surface;
a column and
a universal mounting bracket for mounting one or more interchangeable accessory modules,
wherein the column is connected to the base and the universal mounting bracket is arranged at an end of the column facing away from the base,
wherein the universal mounting bracket has a mechanical mounting interface for mounting and dismounting the one or more interchangeable accessory modules to the platform,
wherein the platform has electrical functionality, and
wherein the platform comprises an identification interface for identifying at least one of the one or more interchangeable accessory modules mounted on the platform and a control unit, wherein the control unit is adapted to obtain identification information about the at least one of the one or more interchangeable accessory modules mounted on the platform, the identification information acquired by means of the identification interface, and to control an adaptation of the electrical functionality of the platform depending on the obtained identification information.

2. The platform according to claim 1, wherein the electrical functionality of the platform comprises an electrical height adjustability of the column.

3. The platform according to claim 2, further comprising an electric drive for electric height adjustment of the column, wherein the electric drive is integrated in the column.

4. The platform according to claim 2, wherein the control unit is configured to control an automatic height adjustment of the column depending on the received identification information.

5. The platform according to claim 1, wherein the universal mounting bracket comprises an electrical connection interface for electrically connecting at least one of the one or more interchangeable accessory modules to the platform,
wherein the mounting interface and the connection interface of the universal mounting bracket are configured in such a way that, by mounting the at least one of the one or more interchangeable accessory modules on the platform by means of the mounting interface, an electrical connection of the at least one of the one or more interchangeable accessory modules to the connection interface is established automatically.

6. The platform according to claim 1, wherein the column is arranged perpendicular to the installation surface when the platform is upright, and wherein the column is telescopically height-adjustable.

7. The platform according to claim 1, further comprising a battery for electrically powering one or more of the platform and at least one of the one or more interchangeable accessory modules mounted on the platform.

8. The platform according to claim 1, wherein the base comprises at least three feet, wherein a roller is arranged on at least two of the at least three feet, respectively, for displacing the platform on the installation surface.

9. The platform according to claim 8, wherein the at least three feet define legs having equal leg lengths pointing away from a connection with the column,
wherein one or more of the at least three feet are pivotable relative to one or more other of the at least three feet about an axis perpendicular to the installation surface.

10. The platform according to claim 1, wherein the universal mounting bracket is pivotally arranged on the column.

11. The platform according to claim 1, wherein the universal mounting bracket, when the platform is upright, is fixedly arranged on the column horizontally or vertically in its main dimension with respect to the installation surface.

12. The platform according to claim 1, wherein the universal mounting bracket comprises a coupling interface for mechanical and/or electrical coupling with another universal mounting bracket of another platform.

13. A variably adaptable piece of furniture comprising:
one or more interchangeable accessory modules; and
a platform, the platform comprising:
a base for placing the platform on an installation surface;
a column connected to the base;
a universal mounting bracket having a mechanical mounting interface, wherein the universal mounting bracket is arranged at an end of the column facing away from the base, and wherein the one or more interchangeable accessory modules are mounted or configured to be mounted on the universal mounting bracket of the platform by means of the mechanical mounting interface;
an identification interface configured for identifying at least one of the one or more interchangeable accessory modules mounted on the platform; and
a control unit,
wherein the platform has electrical functionality,
wherein the control unit is adapted to obtain identification information about the at least one of the one or more interchangeable accessory modules mounted on the platform by means of the identification interface, and
wherein the control unit is adapted to control an adaptation of the electrical functionality of the platform depending on the obtained identification information.

14. The variably adaptable piece of furniture according to claim 13, wherein the one or more interchangeable accessory modules are configured as at least one of
a flat work surface,
a holder for a book, tablet computer or smartphone,
a translationally and/or rotationally movable surface element,
a mount according to a standard of the Video Electronics Standards Association (VESA),
a mechanical holder for objects that configured to be mounted thereon,
an electrical accessory interface for connecting or coupling electrical devices,
a coupling interface (10) for mechanical and/or electrical coupling with a further accessory module,
an integrated whiteboard,
an integrated display,
an integrated, electrical operating or control element, and
a seat.

15. (canceled)

16. A method of controlling a variably adaptable piece of furniture comprising
a platform for a variably adaptable piece of furniture,
a column, and a universal mounting bracket for mounting interchangeable accessory modules,
wherein the platform has a base for placing the platform on an installation surface,
wherein the column is connected to the base and the universal mounting bracket is arranged at an end of the column facing away from the base,
wherein the universal mounting bracket has a mechanical mounting interface for mounting and dismounting interchangeable accessory modules to the platform,
wherein the platform has electrical functionality, and
wherein the platform comprises an identification interface for identifying an accessory module mounted on the platform and a control unit,
wherein the control unit is adapted to obtain identification information about an accessory module mounted on the platform, the identification information acquired by means of the identification interface, and to control an adaptation of the electrical functionality of the platform depending on the obtained identification information, and
an interchangeable accessory module which is mounted configured to be mounted on the universal mounting bracket of the platform by means of the mounting interface,
wherein the method comprises:
the identification interface of the platform automatically identifying the accessory module mounted on the platform,
wherein the control unit obtains identification information about the accessory module mounted on the platform, wherein the identification information is acquired by means of the identification interface and
wherein the control unit controls an adaptation of the electrical functionality of the platform based on the obtained identification information.
